(19) United States
(12) Patent Application Publication
(10) Pub. No.: US 2023/0078503 A1
(43) Pub. Date: Mar. 16, 2023

(54) THERMOPLASTIC POLYURETHANE COMPOSITION, AND DYEABLE FIBER MADE THEREFROM AND METHOD FOR PREPARING THE SAME

(71) Applicant: GUANG XIN POLYMER COMPOSITES CO., LTD., Caotun Township (TW)

(72) Inventors: Wen-Pin Hung, Taichung City (TW); Hung-Chia Yen, Taichung City (TW)

(21) Appl. No.: 17/712,673

(22) Filed: Apr. 4, 2022

(30) Foreign Application Priority Data
Sep. 16, 2021 (TW) 110134595

(51) Int. Cl. C08G 18/83

(52) U.S. Cl. CPC C08G 18/831

(57) ABSTRACT

A thermoplastic polyurethane composition includes a first thermoplastic polyurethane compound and a modifier formed by subjecting a modifier-forming mixture to a thermal mixing process. The modifier-forming mixture includes a second thermoplastic polyurethane compound, a copolyester modifying agent, and a compatibilizer. The copolyester modifying agent is present in an amount ranging from 5 wt % to 30 wt %, and the compatibilizer is present in an amount ranging from 0.5 wt % to 5 wt %, based on a total weight of the thermoplastic polyurethane composition. A dyeable fiber made from and a method for preparing the thermoplastic polyurethane composition are also disclosed.

### CROSS-REFERENCE TO RELATED APPLICATION

This application claims priority of Taiwanese Invention Patent Application No. 110134595, filed on Sep. 16, 2021.

### FIELD

The disclosure relates to a thermoplastic composition and a fiber made therefrom and a method for preparing the same, and more particularly to a thermoplastic polyurethane composition and a dyeable fiber made therefrom and a method for preparing the same.

### BACKGROUND

Taiwanese Invention Patent Application Publication No. 201428148 discloses a method for making a thermoplastic polyurethane fiber. Such method includes the steps of:

a) heating a polyol, a diisocyanate, a chain extender, optionally a crosslinking agent, and a functional modifier, so as to form a first thermoplastic polyurethane compound;

b) heating a polyol, a diisocyanate, a chain extender and optionally a crosslinking agent, so as to form a second thermoplastic polyurethane compound; and

c) mixing the first thermoplastic polyurethane compound and the second thermoplastic polyurethane compound, followed by spinning, so as to obtain the thermoplastic polyurethane fiber having a dyeability.

The abovementioned method for making the thermoplastic polyurethane fiber has some shortcomings. For example, in step c), the first and second thermoplastic polyurethane compounds which are subjected to heating are easily decomposed, such that the first and second thermoplastic polyurethane compounds are difficult to be spun, resulting in a poor productivity of the thermoplastic polyurethane fiber.

### SUMMARY

Therefore, in a first aspect, the present disclosure provides a thermoplastic polyurethane composition that can alleviate at least one of the drawbacks of the prior art, and that includes a first thermoplastic polyurethane compound and a modifier. The modifier is formed by subjecting a modifier-forming mixture to a thermal mixing process. The modifier-forming mixture includes a second thermoplastic polyurethane compound, a copolyester modifying agent, and a compatibilizer. The copolyester modifying agent is formed by subjecting a reaction mixture to a polycondensation reaction. The reaction mixture includes benzenedicarboxylic acid, ethylene glycol and neopentyl glycol. The compatibilizer is a maleic acid anhydride grafted ethylene-octene copolymer. The thermoplastic polyurethane composition has a melt flow rate ranging from 19 g/10 minutes to 21 g/10 minutes. The copolyester modifying agent is present in an amount ranging from 5 wt % to 30 wt %, based on a total weight of the thermoplastic polyurethane composition. The compatibilizer is present in an amount ranging from 0.5 wt % to 5 wt %, based on the total weight of the thermoplastic polyurethane composition.

In a second aspect, the present disclosure provides a dyeable fiber that can alleviate at least one of the drawbacks of the prior art, and that is made from the abovementioned thermoplastic polyurethane composition.

### DETAILED DESCRIPTION

### Thermoplastic Polyurethane Composition

The present disclosure provides a thermoplastic polyurethane composition that includes a first thermoplastic polyurethane compound and a modifier. The modifier is formed by subjecting a modifier-forming mixture to a thermal mixing process. The modifier-forming mixture includes a second thermoplastic polyurethane compound, a copolyester modifying agent, and a compatibilizer. The copolyester modifying agent is formed by subjecting a reaction mixture to a polycondensation reaction. The reaction mixture includes benzenedicarboxylic acid, ethylene glycol, and neopentyl glycol. The compatibilizer is a maleic acid anhydride grafted ethylene-octene copolymer. The first and second thermoplastic polyurethane compounds may be identical or different. The thermoplastic polyurethane composition may have a melt flow rate ranging from 19 g/10 minutes to 21 g/10 minutes. Based on a total weight (i.e. 100 wt %) of the thermoplastic polyurethane composition, the copolyester modifying agent is present in an amount ranging from 5 wt % to 30 wt %, and the compatibilizer is present in an amount ranging from 0.5 wt % to 5 wt %, In some embodiments, the compatibilizer may be present in an amount ranging from 1 wt % to 5 wt %, based on the total weight of the thermoplastic polyurethane composition. In some embodiments, the thermoplastic polyurethane composition may be prepared by mixing the first thermoplastic polyurethane compound and the modifier in a non-thermal mixing manner.

### Method for Preparing Thermoplastic Polyurethane Composition

The present disclosure also provides a method for preparing a thermoplastic polyurethane composition, including:

providing the first thermoplastic polyurethane compound;

providing the modifier-forming mixture;

subjecting the modifier-forming mixture (i.e. the second thermoplastic polyurethane compound, the copolyester modifying agent and the compatibilizer) to a thermal mixing process so as to form the modifier; and

mixing the first thermoplastic polyurethane compound and the modifier in a non-thermal mixing manner so as to prepare the thermoplastic polyurethane composition.

In some embodiments, the preparation method may further include granulating the modifier-forming mixture (i.e. the second thermoplastic polyurethane compound, the copolyester modifying agent and the compatibilizer) to form the modifier. The modifier thus formed is in a granular form.

The term “thermal mixing” refers to mixing under heating. The term “non-thermal mixing” refers to mixing without heating.

### First Thermoplastic Polyurethane Compound

In some embodiments, the first thermoplastic polyurethane compound may be polyester-based thermoplastic polyurethane or polyether-based thermoplastic polyurethane. In some embodiments, the first thermoplastic polyurethane compound may have a melting point ranging from 160° C. to 220° C. In some embodiments, the first thermoplastic polyurethane compound may have a Shore hardness ranging from 60 A (Shore A) to 50 D (Shore D).

### Modifier

In some embodiments, a ratio of an amount of the first thermoplastic polyurethane compound to an amount of the modifier may range from 90:10 to 70:30.

### Second Thermoplastic Polyurethane Compound

In some embodiments, the second thermoplastic polyurethane compound may be polyester-based thermoplastic polyurethane or polyether-based thermoplastic polyurethane. In some embodiments, the second thermoplastic polyurethane compound may have a melting point ranging from 160° C. to 220° C. In some embodiments, the second thermoplastic polyurethane compound may have a Shore hardness ranging from 60 A (Shore A) to 50 D (Shore D).

### Copolyester Modifying Agent

The benzenedicarboxylic acid may be selected from the group consisting of phthalic acid, isophthalic acid, terephthalic acid, and combinations thereof. In an exemplary embodiment, the benzenedicarboxylic acid is terephthalic acid.

The neopentyl glycol is conducive to improving the dyeability (by a disperse dye) of a dyeable fiber made from the thermoplastic polyurethane composition, as well as the process stability of the thermoplastic polyurethane composition during mixing and spinning processes.

In some embodiments, the copolyester modifying agent may be present in an amount ranging from 8 wt % to 24 wt %, based on the total weight of the thermoplastic polyurethane composition.

### Compatibilizer

The compatibilizer has an excellent heat resistance and a low melting point, therefore being conducive to enhancing the process stability of the thermoplastic polyurethane composition during mixing and spinning processes.

In some embodiments, the compatibilizer may be present in an amount ranging from 0.5 wt % to 1.5 wt %, based on the total weight of the thermoplastic polyurethane composition. In other embodiments, the compatibilizer may be present in an amount ranging from 3 wt % to 5 wt %, based on the total weight of the thermoplastic polyurethane composition.

### Dyeable Fiber

The dyeable fiber may be produced by subjecting the thermoplastic polyurethane composition to a spinning process.

There is no limitation on the spinning process for making the dyeable fiber. A well-known fiber production technique can be used in the spinning process. In some embodiments, the spinning process speed may range from 600 m/minutes to 1200 m/minutes.

The disclosure will be further described by way of the following examples. However, it should be understood that the following examples are solely intended for the purpose of illustration and should not be construed as limiting the disclosure in practice.

### Example 1 (E1)

Polyester-based thermoplastic polyurethane (serving as the second thermoplastic polyurethane compound of the present disclosure; melt flow rate: 18 at 220° C./2.16 Kg; Shore surface hardness: 95 A; melting point: 195° C.; commercially available from JO-FON Chemical Industry Co., Ltd., Taiwan; Model No: TPU-95A) and a copolyester modifying agent (melt flow rate: 20 at 220° C./2.16 Kg; formed by subjecting terephthalic acid, ethylene glycol and neopentyl glycol to a polycondensation reaction; commercially available from Dragon Special Resin Co. Ltd.; Model No: TL-3015) were dried, such that each of the polyester-based thermoplastic polyurethane and the copolyester modifying agent had a water content lower than 200 ppm. After that, 15 wt % of the dried polyester-based thermoplastic polyurethane, 80 wt % of the dried copolyester modifying agent, and 5 wt %, of a compatibilizer, which was a maleic acid anhydride grafted ethylene-octene copolymer (melt flow rate: 8 at 230° C./5 Kg, commercially available from ExxonMobil; Model No: Exxelor VA1840), were placed in a double screw extruder, followed by mixing and granulating at a temperature ranging from 200° C. to 220° C., so as to form a granular modifier.

90 wt % of polyester-based thermoplastic polyurethane (serving as the first thermoplastic polyurethane compound of the present disclosure; having the same property and commercial availability as the aforesaid polyester-based thermoplastic polyurethane serving as the second thermoplastic polyurethane compound of the present disclosure) and 10 wt % of the granular modifier were mixed, so as to form a thermoplastic polyurethane composition. After that, the thermoplastic polyurethane composition was placed in a spinning equipment including a spinneret machine, and was then subjected to a melt spinning treatment for 8 hours, so as to obtain a partial oriented yarn (POY) fiber (specification: 150 d (danel)/24 f (filament)). The spinneret machine included a spinneret having a temperature ranging from 220° C. to 240° C. In the melt spinning treatment, the melting temperature was 230° C. and the spinning speed was 600 m/minutes.

### Example 2 (E2)

The POY fiber of Example 2 was prepared generally according to the production procedure of Example 1, except that the amount of the polyester-based thermoplastic polyurethane serving as the first thermoplastic polyurethane compound of the present disclosure and the amount of the granular modifier were 80 wt %, and 20 wt %, respectively.

### Example 3 (E3)

The POY of Example 3 was prepared generally according to the production procedure of Example 1, except that the amount of the polyester-based thermoplastic polyurethane serving as the first thermoplastic polyurethane compound of the present disclosure and the amount of the granular modifier were 70 wt % and 30 wt %, respectively.

### Comparative Example 1 (CE1)

The POY of Comparative Example 1 was prepared generally according to the production procedure of Example 1, except that the granular modifier was not prepared and applied to mix with the polyester-based thermoplastic polyurethane serving as the first thermoplastic polyurethane compound of the present disclosure (namely, only the polyester-based thermoplastic polyurethane serving as the first thermoplastic polyurethane compound of the present disclosure was provided and subjected to the melt spinning treatment).

### Comparative Example 2 (CE2)

The POY of Comparative Example 2 was prepared generally according to the production procedure of Example 1, except that only the granular modifier was prepared and subjected to the melt spinning treatment (namely, the polyester-based thermoplastic polyurethane serving as the first thermoplastic polyurethane compound of the present disclosure was not provided and mixed with the granular modifier). Specifically, 87 wt % of the dried polyester-based thermoplastic polyurethane (serving as the second thermoplastic polyurethane compound of the present disclosure), 8 wt % of the dried copolyester modifying agent, and 5 wt % of the compatibilizer were used to form the granular modifier.

### Comparative Example 3 (CE3)

The POY fiber of Comparative Example 3 was prepared generally according to the production procedure of Comparative Example 2, except that 79 wt % of the dried polyester-based thermoplastic polyurethane and 16 wt % of the dried copolyester modifying agent were applied to form the granular modifier.

### Comparative Example 4 (CE4)

The POY fiber of Comparative Example 4 was prepared generally according to the procedure of Comparative Example 2, except that 71 wt % of the dried polyester-based thermoplastic polyurethane and 24 wt % of the dried copolyester modifying agent were applied to form the granular modifier.

### Property Evaluation

The thermoplastic polyurethane compositions and the POY fibers of Examples 1 to 3, as well as the polyester-based thermoplastic polyurethane or the granular modifier and the POY fibers of Comparative Examples 1 to 4, were subjected to the following property evaluation tests.

### 1. Determination of Melt Flow Rate (MFR)

The melt flow rate (in g/10 minutes) of each of the thermoplastic polyurethane compositions of Examples 1 to 3, the polyester-based thermoplastic polyurethane of Comparative Example 1, and the granular modifiers of Comparative Examples 2 to 4 was measured using a melt flow indexer (Manufacturer: Gotech Testing Machines Inc.; Model No: GT-7200) according to ASTM D1238-20 at a load of 2.16 Kg and a temperature of 220° C.

### 2. Determination of Spinnability

The spinnability of the thermoplastic polyurethane composition of each example, that of the polyester-based thermoplastic polyurethane of Comparative Example 1, and that of the granular modifier of Comparative Examples 2 to 4 were evaluated based on the number of breakage of the POY fiber formed on a single spindle during a melt spinning process. The spinnability was evaluated according to the standards below:
good: the number of breakage was less than 1;
fair: the number of breakage ranged from 1 to 3; and
poor: the number of breakage was greater than 3.

### 3. Dye Intensity

The POY fibers of the Examples 1 to 3 and Comparative Examples 0.1 to 4 were processed using a knitting machine having 8 of 6-inch circular knitting needles, so as to obtain garters. After that, the garters were soaked in a brown disperse dye (purchased from RIITS Trading Co., Ltd.; Model No: HW-XFN) at a temperature of 130° C. for 40 minutes, so as to obtain dyed garters. Subsequently, the dye intensity (IL value) of each of the dyed garters was measured using a spectrophotometer (Manufacturer: Datacolor; Model No.: 650). The dye intensity ranges from 0 to 100, in which 0 represents the highest dye intensity (black), and 100 represents the lowest dye intensity (white).

### 4. Colorfastness to Washing

The dyed garters were subjected to washing with water having a temperature of 80° C. for 20 minutes, followed by drying at a temperature of 130° C. for 30 seconds. The colorfastness to washing regarding the garters was tested according to AATCC 61-1A (version 2020). The colorfastness to washing was evaluated based on 5 ranks, in which rank 1 represents the least satisfactory colorfastness to washing, and rank 5 represents the most satisfactory colorfastness to washing.

The results of the aforesaid property evaluation tests are shown in Table 1 below.

TABLE 1

| | | Example | | | Comparative example | | | |
|---|---|---|---|---|---|---|---|---|
| | | 1 | 2 | 3 | 1 | 2 | 3 | 4 |
| Thermoplastic | MFR | 19.5 | 20.2 | 20.8 | 21.4 | 23.6 | 24.2 | 25.1 |
| polyurethane | Spinnability | Good | Good | Fair | Good | Poor | Poor | Poor |
| composition/ | | | | | | | | |
| polyester- | | | | | | | | |
| based thermo- | | | | | | | | |
| plastic | | | | | | | | |
| polyurethane/ | | | | | | | | |
| granular | | | | | | | | |
| modifier | | | | | | | | |
| POY fiber | Dye intensity | 52.5 | 38.6 | 37.8 | 64.8 | 53.5 | 42.2 | 41.6 |
| | (L value) | | | | | | | |
| | Colorfastness | 3 | 3.5 | 3.5 | 2 | 3 | 3 | 3 |
| | to washing | | | | | | | |
| | (rank) | | | | | | | |

Compared with the POY fiber of Comparative Example 1, each of the POY fibers of Examples 1 to 3 had a dye intensity (L) ranging from 37.8 to 52.5, and had a rank of colorfastness to washing ranging from 3 to 5. Therefore, by mixing the modifier with the first thermoplastic polyurethane compound without heating to prepare the thermoplastic polyurethane composition of the present disclosure, the POY fiber made from the thermoplastic polyurethane composition of the present disclosure has a good dyeability and a satisfactory colorfastness to washing.

In addition, in regard to the Comparative Examples 2 to 4, the dried polyester-based thermoplastic polyurethane was subjected to a thermal mixing process and a granulation process, such that a portion of the dried polyester-based thermoplastic polyurethane underwent thermal cracking, and such that the granular modifier formed and directly used to produce the POY fiber had a high MFR. Therefore, during the spinning process for making the POY fiber, breakage occurred several times, resulting in a poor spinnability.

In sum, by virtue of the first thermoplastic polyurethane compound and the modifier, the thermoplastic polyurethane composition of the present disclosure might have an excellent spinnability, and the dyeable fiber made from such thermoplastic polyurethane composition might have a good dyeability and a good colorfastness to washing.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A thermoplastic polyurethane composition, comprising:
a first thermoplastic polyurethane compound; and
a modifier formed by subjecting a modifier-forming mixture to a thermal mixing process, the modifier-forming mixture including
a second thermoplastic polyurethane compound;
a copolyester modifying agent formed by subjecting a reaction mixture to a polycondensation reaction, the reaction mixture including benzenedicarboxylic acid, ethylene glycol, and neopentyl glycol; and
a compatibilizer which is a maleic acid anhydride grafted ethylene-octene copolymer, wherein
the thermoplastic polyurethane composition has a melt flow rate ranging from 19 g/10 minutes to 21 g/10 minutes,
the copolyester modifying agent is present in an amount ranging from 5 wt % to 30 wt %, based on a total weight of the thermoplastic polyurethane composition, and
the compatibilizer is present in an amount ranging from 0.5 wt % to 5 wt %, based on the total weight of the thermoplastic polyurethane composition.

2. The thermoplastic polyurethane composition of claim 1, wherein the copolyester modifying agent is present in an amount ranging from 8 wt % to 24 wt %, based on the total weight of the thermoplastic polyurethane composition.

3. The thermoplastic polyurethane composition of claim 1, wherein the compatibilizer is present in an amount ranging from 0.5 wt % to 1.5 wt %, based on the total weight of the thermoplastic polyurethane composition.

4. The thermoplastic polyurethane composition of claim 1, wherein each of the first and second thermoplastic polyurethane compounds has a melting point ranging from 160° C. to 220° C.

5. The thermoplastic polyurethane composition of claim 1, wherein a ratio of an amount of the first thermoplastic polyurethane compound to an amount of the modifier ranges from 90:10 to 70:30.

6. The thermoplastic polyurethane composition of claim 1, wherein each of the first and second thermoplastic polyurethane compounds is one of polyester-based thermoplastic polyurethane and polyether-based thermoplastic polyurethane.

7. The thermoplastic polyurethane composition of claim 1, which is prepared by mixing the first thermoplastic polyurethane compound and the modifier in a non-thermal mixing manner.

8. The thermoplastic polyurethane composition of claim 1, wherein the first and second thermoplastic polyurethane compounds are identical or different.

9. A dyeable fiber, comprising a thermoplastic polyurethane composition as claimed in claim 1.

10. The dyeable fiber of claim 9, which is produced by subjecting the thermoplastic polyurethane composition to a spinning process.
